(19) United States
(12) Patent Application Publication
(10) Pub. No.: US 2023/0055775 A1
(43) Pub. Date: Feb. 23, 2023

(54) APPARATUS AND METHODS FOR PUBLISHING VIDEO CONTENT

(71) Applicant: ARTI D2 LTD., Tel Aviv (IL)

(72) Inventors: Yaron Zakai-Or, Kfar Haim (IL); Ido Lempert, Tel Aviv (IL); Dror Belkin, Ramat Hasharon (IL); Avner Vilan, Kibbutz Negba (IL)

(21) Appl. No.: 17/904,318

(22) PCT Filed: Feb. 18, 2021
(86) PCT No.: PCT/IB2021/051365

§ 371 Date: Aug. 16, 2022

Related U.S. Application Data
(60) Provisional application No. 62/978,861, filed on Feb. 20, 2020.
(60) Provisional application No. 63/034,418, filed on Jun. 4, 2020.

(51) Int. Cl. G06T 19/00; H04N 21/431

(52) U.S. Cl. CPC G06T 19/006; H04N 21/4316

(57) ABSTRACT

Apparatus and methods for are described for publishing video content, based upon a video feed that is recorded at a first site. In real-time with respect to the recording of the video feed, and using one or more computer processors (23, 24, 27), one or more dispositions are identified within image frames. Data that are indicative of the one or more dispositions within the image frames are communicated to a cloud-based, remote computer server that is remote from the first site. One or more augmented-reality objects (25) are received from the cloud-based, remote computer server, the augmented-reality objects (25) being positioned and oriented to correspond to the positions identified within the image frames belonging to the video feed. The video feed with the augmented-reality objects (25) overlaid upon the image frames is published. Other applications are also described.

### CROSS-REFERENCES TO RELATED APPLICATIONS

The present application claims priority from U.S. Provisional Patent Application 62/978,861 to Zakai-Or, entitled “Apparatus and methods for publishing video content,” filed Feb. 20, 2020, and U.S. Provisional Patent Application 63/034,418 to Zakai-Or, entitled “Apparatus and methods for publishing video content,” filed Jun. 4, 2020. Both of the aforementioned US Provisional applications are incorporated herein by reference.

### FIELD OF EMBODIMENTS OF THE INVENTION

Some applications of the present invention generally relate to publishing (e.g., broadcasting) video content. In particular, some applications relate to publishing video content that includes augmented-reality objects.

### BACKGROUND

Augmented reality (AR) is used to describe an experience in which real-world elements are combined with computer-generated output to create a mixed-reality environment. Such computer-generated outputs may include audio outputs, haptic outputs, visual outputs, etc.

### SUMMARY OF EMBODIMENTS

In accordance with some applications of the present invention, one or more dispositions are identified within image frames belonging to a video feed that is recorded at a first site (e.g., by identifying markers within the image frames). For some applications, data that are indicative of the one or more dispositions within the image frames belonging to the video feed are communicated to a cloud-based, remote computer server that is remote from the first site. Typically, one or more augmented-reality objects are received from the cloud-based, remote computer server, the augmented-reality objects being positioned and oriented to correspond to the identified dispositions. For some applications, the video feed is published with the augmented-reality objects overlaid upon the image frames. Typically, all of the above-mentioned steps are performed in real-time (e.g., within less than 30 seconds (e.g., less than 20 seconds, less than 10 seconds, less than 5 seconds, and/or less than 1 second) with respect to the recording of the video feed.

There is therefore provided, in accordance with some applications of the present invention, a method for publishing video content, based upon a video feed that is recorded at a first site, the method including:

in real-time with respect to the recording of the video feed, and using one or more computer processors:
identifying one or more dispositions within image frames belonging to the video feed;
communicating data that are indicative of the one or more dispositions within the image frames belonging to the video feed to a cloud-based, remote computer server that is remote from the first site;
receiving one or more augmented-reality objects from the cloud-based, remote computer server, the augmented-reality objects being positioned and oriented to correspond to the positions identified within the image frames belonging to the video feed; and
publishing the video feed with the augmented-reality objects overlaid upon the image frames.

In some applications, publishing the video feed with the augmented-reality objects overlaid upon the image frames includes broadcasting the video feed with the augmented-reality objects overlaid upon the image frames.

In some applications, the one or more augmented-reality objects include one or more augmented-reality objects selected from the group consisting of: a title, text, a photograph, a video, a graphs, a 3D-object, a website, a social media feed, and any combination thereof.

In some applications, the one or more augmented-reality objects include a data source from an application programming interface.

In some applications, the video feed has a given frame rate, and receiving the augmented- reality objects from the cloud-based, remote computer server includes receiving the augmented- reality objects from the cloud-based, remote computer server at a frame rate that matches the given frame rate.

In some applications, identifying the one or more dispositions within image frames belonging to the video feed includes, for respective image frames belonging to the video feed, identifying dispositions that are different from each other.

In some applications,

the method further includes, in real-time with respect to the recording of the video feed, selecting the one or more augmented-reality objects that are to be overlaid upon respective portions of the video feed, and

receiving the augmented-reality objects from the cloud-based, remote computer server includes receiving the selected augmented-reality objects from the cloud-based, remote computer server in real-time with respect to the selecting of the one or more augmented-reality objects.

In some applications, selecting the one or more augmented-reality objects that are to be overlaid upon respective portions of the video feed in real-time with respect to the recording of the video feed includes selecting the one or more augmented-reality objects from a plurality of augmented-reality objects that are displayed upon a user interface device.

In some applications, the method further includes receiving a gesture from a user who appears within the video feed, and in response thereto adjusting the augmented-reality object.

In some applications, adjusting the augmented-reality object includes changing a size of the augmented-reality object.

In some applications, adjusting the augmented-reality object includes changing an orientation of the augmented-reality object.

In some applications, adjusting the augmented-reality object includes changing the augmented-reality object.

In some applications, receiving the one or more augmented-reality objects from the cloud-based, remote computer server includes receiving an alpha channel that contains the one or more augmented-reality objects from the cloud-based, remote computer server.

In some applications, receiving the alpha channel from the cloud-based, remote computer server includes receiving an alpha channel that is generated using a gaming engine.

In some applications, identifying one or more dispositions within image frames belonging to the video feed includes identifying dispositions of one or more physical markers that are located within the image frames belonging to the video feed.

In some applications, the method further includes at least partially reducing a visibility of the one or more physical markers within the image frames.

In some applications, reducing the visibility of the one or more physical markers within the image frame includes reducing the visibility of the one or more physical markers from within the image frames such that it is as if the physical markers have been removed from the image frame.

In some applications, reducing the visibility of the one or more physical markers within the image frame includes, within each of the image frames:

identifying characteristics of areas of the image frame that surround each of the one or more physical markers, and

generating masks to overlay upon the one or more markers, such that the masks blend in with corresponding surrounding areas.

In some applications, reducing the visibility of the one or more physical markers within the image frame includes running a machine-learning algorithm that generates masks to overlay upon the one or more markers, such that the masks blend in with areas that surround each of the one or more physical markers.

In some applications, the method further includes automatically matching lighting-related parameters of the one or more augmented-reality objects with lighting-related parameters within image frames of the video feed.

In some applications, automatically matching the lighting-related parameters includes matching one or more lighting-related parameters selected from the group consisting of: light intensity, light-source angle, white balance, light-source type, and light-source position.

In some applications, automatically matching the lighting-related parameters includes automatically matching the lighting-related parameters by running a machine learning-algorithm.

In some applications, automatically matching the lighting-related parameters includes determining lighting-related parameters within the image frames, and applying lighting-related parameters to the augmented-reality objects based on the lighting-related parameters that were determined within the image frames.

In some applications, automatically matching the lighting-related parameters includes determining lighting-related parameters to apply to the augmented-reality objects in order to match the lighting-related parameters of the augmented-reality objects to those of the image frames, without directly determining the lighting-related parameters within the image frames.

There is further provided, in accordance with some applications of the present invention, a method for publishing video content, based upon a video feed that is recorded at a first site, the method including:

in real-time with respect to the recording of the video feed, and using a cloud-based computer server disposed at a second site that is remote from the first site:
receiving an identification of one or more dispositions identified within image frames belonging to the video feed;
receiving an indication of one or more augmented-reality objects to be displayed within the video feed; and
publishing the video feed with the augmented-reality objects overlaid upon the image frames belonging to the video feed at positions and orientations corresponding to the one or more dispositions that were identified within the image frames.

There is further provided, in accordance with some applications of the present invention, apparatus for publishing video content on a video output device, based upon a video feed that is recorded at a first site, the apparatus including:

one or more computer processors configured, in real-time with respect to the recording of the video feed, to:
identify one or more dispositions within image frames belonging to the video feed;
communicate data that are indicative of the one or more dispositions within the image frames belonging to the video feed to a cloud-based, remote computer server that is remote from the first site;
receive one or more augmented-reality objects from the cloud-based, remote computer server, the augmented-reality objects being positioned and oriented to correspond to the positions identified within the image frames belonging to the video feed; and
publish the video feed on the video output device, with the augmented-reality objects overlaid upon the image frames.

In some applications, the one or more computer processors are configured to broadcast the video feed with the augmented-reality objects overlaid upon the image frames.

In some applications, the one or more augmented-reality objects include one or more augmented-reality objects selected from the group consisting of: a title, text, a photograph, a video, a graphs, a 3D-object, a website, a social media feed, and any combination thereof.

In some applications, the one or more augmented-reality objects include a data source from an application programming interface.

In some applications, the video feed has a given frame rate, and the one or more computer processors are configured to receive the augmented-reality objects from the cloud-based, remote computer server at a frame rate that matches the given frame rate.

In some applications, the one or more computer processors are configured to identify the one or more dispositions within image frames belonging to the video feed by identifying dispositions that are different from each other, for respective image frames belonging to the video feed.

In some applications, the one or more computer processors are configured:

in real-time with respect to the recording of the video feed, to receive an input indicating a selection of the one or more augmented-reality objects that are to be overlaid upon respective portions of the video feed, and

to receive the selected augmented-reality objects from the cloud-based, remote computer server in real-time with respect to the selecting of the one or more augmented-reality objects.

In some applications, the one or more computer processors are configured to receive the input by receiving an input from a user interface device by receiving an input indicating a selection of the one or more augmented-reality objects from a plurality of augmented-reality objects that are displayed upon the user interface device.

In some applications, the one or more computer processors are configured to receive a gesture from a user who appears within the video feed, and in response thereto to adjust the augmented-reality object.

In some applications, the one or more computer processors are configured to adjust the augmented-reality object by changing a size of the augmented-reality object.

In some applications, the one or more computer processors are configured to adjust the augmented-reality object by changing an orientation of the augmented-reality object.

In some applications, the one or more computer processors are configured to adjust the augmented-reality object by changing the augmented-reality object.

In some applications, the one or more computer processors are configured to receive the one or more augmented-reality objects from the cloud-based, remote computer server by receiving an alpha channel that contains the one or more augmented-reality objects from the cloud-based, remote computer server.

In some applications, the one or more computer processors are configured to receive the alpha channel from the cloud-based, remote computer server by receiving an alpha channel that is generated using a gaming engine.

In some applications, the one or more computer processors are configured to identify the one or more dispositions within image frames belonging to the video feed by identifying dispositions of one or more physical markers that are located within the image frames belonging to the video feed.

In some applications, the one or more computer processors are configured to at least partially reduce a visibility of the one or more physical markers within the image frames.

In some applications, the one or more computer processors are configured to at least partially reduce the visibility of the one or more physical markers from within the image frames such that it is as if the physical markers have been removed from the image frame.

In some applications, the one or more computer processors are configured to at least partially reduce the visibility of the one or more physical markers within the image frame by, within each of the image frames:

identifying characteristics of areas of the image frame that surround each of the one or more physical markers, and

generating masks to overlay upon the one or more markers, such that the masks blend in with corresponding surrounding areas.

In some applications, the one or more computer processors are configured to at least partially reduce the visibility of the one or more physical markers within the image frame by running a machine-learning algorithm that generates masks to overlay upon the one or more markers, such that the masks blend in with areas that surround each of the one or more physical markers.

In some applications, the one or more computer processors are configured to automatically match lighting-related parameters of the one or more augmented-reality objects with lighting- related parameters within image frames of the video feed.

In some applications, the one or more computer processors are configured to automatically match one or more lighting-related parameters selected from the group consisting of: light intensity, light-source angle, white balance, light-source type, and light-source position.

In some applications, the one or more computer processors are configured to automatically match the lighting-related parameters by running a machine learning-algorithm.

In some applications, the one or more computer processors are configured to automatically match the lighting-related parameters by determining lighting-related parameters within the image frames, and applying lighting-related parameters to the augmented-reality objects based on the lighting-related parameters that were determined within the image frames.

In some applications, the one or more computer processors are configured to automatically match the lighting-related parameters by determining lighting-related parameters to apply to the augmented-reality objects in order to match the lighting-related parameters of the augmented- reality objects to those of the image frames, without directly determining the lighting-related parameters within the image frames.

There is further provided, in accordance with some applications of the present invention, apparatus for publishing video content on a video output device, based upon a video feed that is recorded at a first site, the apparatus including:

one or more computer processors configured, in real-time with respect to the recording of the video feed, and using a cloud-based computer server disposed at a second site that is remote from the first site:
to receive an identification of one or more dispositions identified within image frames belonging to the video feed;
to receive an indication of one or more augmented-reality objects to be displayed within the video feed; and
to publish the video feed with the augmented-reality objects overlaid upon the image frames belonging to the video feed at positions and orientations corresponding to the one or more dispositions that were identified within the image frames.

There is further provided, in accordance with some applications of the present invention, a computer software product including a non-transitory computer-readable medium in which program instructions are stored, which instructions, when read by a computer cause the computer to perform the steps of:

in real-time with respect to the recording of a video feed at a first site:
identifying one or more dispositions within image frames belonging to the video feed;
communicating data that are indicative of the one or more dispositions within the image frames belonging to the video feed to a cloud-based, remote computer server that is remote from the first site;
receiving one or more augmented-reality objects from the cloud-based, remote computer server, the augmented-reality objects being positioned and oriented to correspond to the positions identified within the image frames belonging to the video feed; and
publishing the video feed with the augmented-reality objects overlaid upon the image frames.

There is further provided, in accordance with some applications of the present invention, a computer software product including a non-transitory computer-readable medium in which program instructions are stored, which instructions, when read by a computer cause the computer to perform the steps of:

in real-time with respect to the recording of a video feed at a first site, and using a cloud-based computer server disposed at a second site that is remote from the first site:
receiving an identification of one or more dispositions identified within image frames belonging to the video feed;
receiving an indication of one or more augmented-reality objects to be displayed within the video feed; and
publishing the video feed with the augmented-reality objects overlaid upon the image frames belonging to the video feed at positions and orientations corresponding to the one or more dispositions that were identified within the image frames.

The present invention will be more fully understood from the following detailed description of embodiments thereof, taken together with the drawings, in which:

### BRIEF DESCRIPTION OF THE DRAWINGS

FIG. 1A and 1B are schematic illustrations of components of a system that is used to publish a video feed, in accordance with some applications of the present invention;

FIGS. 2A, 2B and 2C are schematic illustrations of examples of frames of a video feed that include augmented reality objects overlaid thereon, in accordance with some applications of the present invention; and

FIG. 3 is a flowchart showing steps of a method that are performed in accordance with some applications of the present invention.

### DETAILED DESCRIPTION OF EMBODIMENTS

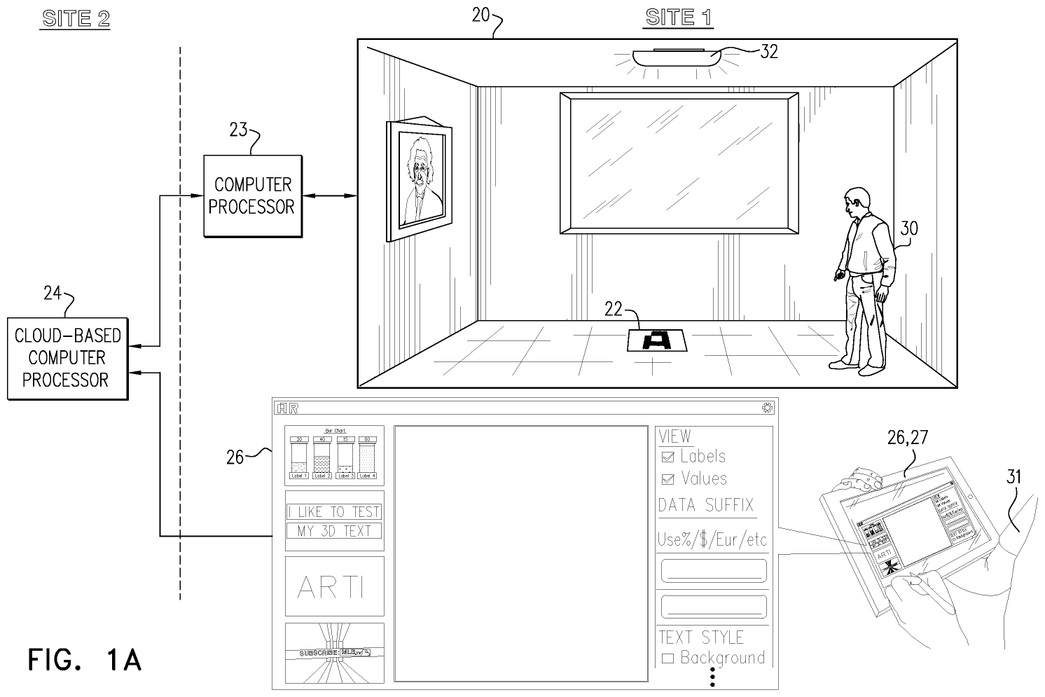

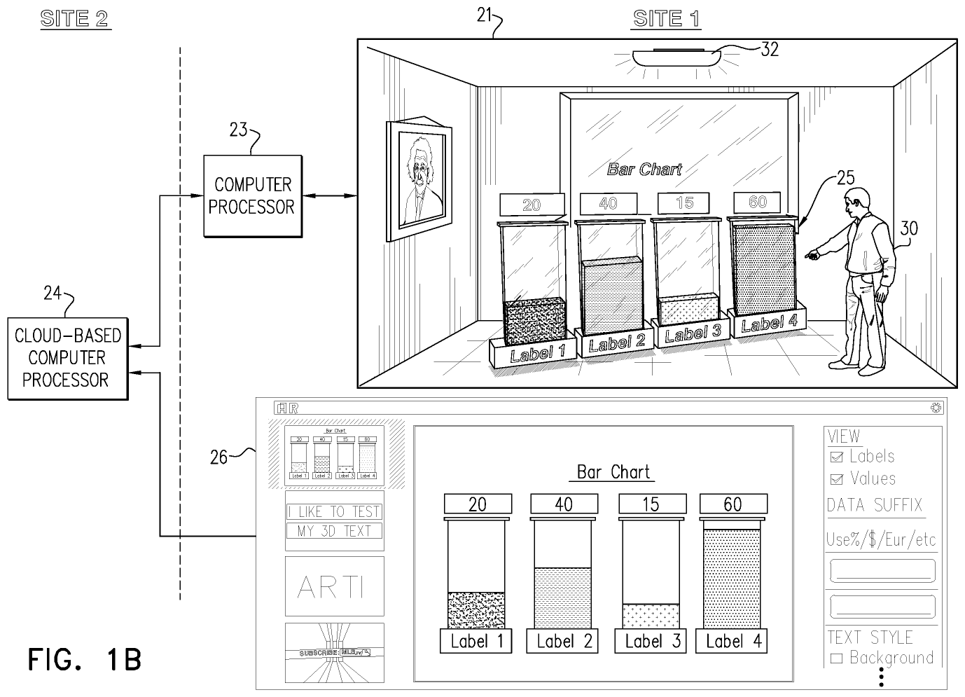

Reference is now made to FIGS. 1A and 1B, which are schematic illustrations of components of a system that is used to publish a video feed, in accordance with some applications of the present invention. FIG. 1A shows a schematic illustration of a screen 20 showing a video that is being recorded by a video camera (not shown) at a first site. For some applications, one or more dispositions within image frames belonging to the video feed are identified, i.e., the position and orientation of one or more objects within the video feed, with respect to the video camera or to an external frame of reference, are identified. Typically, the dispositions are identified by identifying the dispositions (i.e., positions and/or orientations with respect to the video camera or to an external frame of reference) of one or more markers 22 within the video. For example, a computer processor 23 that is disposed at the first site may identify the one or more markers 22 within the video. Typically, during the recording of the video feed, the markers are tracked, such that the dispositions of the one or more markers within respective image frames belonging to the video feed are identified. For some applications, data that are indicative of the identified dispositions are communicated from computer processor 23 to a remote computer server 24 that is disposed at a second site that is remote from the first site. Typically, the remote computer processor is a cloud-based computer server.

For some applications, cloud-based, remote computer server 24 communicates, to computer processor 23, one or more augmented-reality objects 25 that are positioned and oriented such as to correspond to the identified dispositions within the image frames belonging to the video feed. For some such applications, the augmented-reality objects are communicated via an alpha channel, for example via an alpha channel that is generated using a gaming engine (such as the Unreal Engine). Typically, the augmented-reality objects are then overlaid upon the image frames belonging to the video feed at the one or more dispositions that were identified within the image frames. Further typically, the video feed is published (e.g., broadcast) with the augmented-reality objects overlaid thereon. Typically, the steps between the recording of the video feed and the publishing of the video feed with the augmented-reality objects overlaid thereon are performed in real-time with respect to the recording of the video feed. For example, the time between the recording of the video feed and the publishing of the video feed with the augmented-reality objects overlaid thereon may be less than 30 seconds (e.g., less than 20 seconds, less than 10 seconds, less than 5 seconds, and/or less than 1 second).

For some applications, the system is configured such that a user is able to select the one or more augmented-reality objects 25 that are to be overlaid upon respective portions of the video feed in real-time (e.g., within less than 30 seconds (e.g., less than 20 seconds, less than 10 seconds, less than 5 seconds, and/or less than 1 second)) with respect to the recording of the video feed. For example, FIGS. 1A and 1B show a user interface device 26 disposed at the first site (i.e., the site at which the video is recorded). (It is noted that the scope of the present application includes using a user interface device disposed at yet another site that is remote from both the first site (at which the video is being recorded) and the second site (at which the cloud-based, remote computer server is disposed).) By way of example, FIGS. 1A and 1B show that the user can select to show a chart, 3D text, a graphic, and/or a video (i.e., an augmented reality video that will be embedded within the video feed), or a different type of augmented reality object. In the example shown in FIG. 1B, the user selects to show the bar chart. As indicated in FIG. 1A, this selection is communicated to cloud-based, remote computer server 24. The cloud-based, remote computer server then communicates the selected augmented-reality object (disposed at the correct position and orientation), to computer processor 23 at the first site, and the bar chart is overlaid upon a modified video feed 21, as indicated in FIG. 1B. Typically, computer processor 23 performs the overlaying of the augmented-reality object upon the video feed. For some applications, user interface device includes a computer processor 27, which is configured to perform one or more steps described herein.

It is noted that, in the example shown in FIG. 1B, augmented-reality object 25 is placed immediately above marker 22. However, in accordance with respective applications, the augmented-reality object may be placed within the video feed at other positions with respect to the marker, such as, below the marker, to one side of the marker, and/or overlaid upon the marker. It is noted that in the example shown in FIGS. 1A-B, the user can select to show particular examples of augmented reality objects. However, the scope of the present invention includes selecting to show any of a plurality of different types of augmented-reality object, including but not limited to a title, text, a photograph, a video, a graph, a 3D-object, a website, a social media feed, a data source from an application programming interface, and/or any combination thereof.

Typically, user interface device 26 is a device that includes a computer processor and a user interface, such as a personal computer, tablet computer, and/or a mobile device (e.g., a smartphone). Further typically, the user is able to select which augmented-reality objects 25 to show at any point during the video feed in an intuitive manner. For example, the user interface device may be configured such that the user can swipe though a selection of pre-prepared augmented-reality objects, and then click on (or otherwise select) one of the augmented-reality objects to be displayed in real-time with respect to the video feed being recorded. Alternatively, the user may select augmented-reality objects that have not been prepared, for example, the user may select a publicly-available video, website, social media feed, web-based graphical content, etc. Typically, the augmented-reality objects include one or more of a title, text, a photograph, a video, a graph, a 3D-object, a website, a social media feed, a data source from an application programming interface, and/or any combination thereof. For some applications, the user accesses a web browser on the user interface device and the user selects which augmented-reality objects to show at any point during the video feed, via the web browser. In accordance with respective applications, the user interface device may be located at the first site, the second site, and/or a third site that is remote from both the first and second sites.

As shown in FIGS. 1A and 1B, for some applications a user 30 appears in the video feed. For some such applications, the user who appears in the video feed controls the user interface device, such as to select and/or otherwise control the augmented reality object 25 that appears in the video feed. Alternatively or additionally a further user 31 (shown in FIG. 1A) controls the user interface device, such as to select and/or otherwise control the augmented reality object that appears in the video feed. For example, as shown in FIG. 1A, a second user who is located in close proximity to the first user may control the user interface device. Or, a second user who is located remotely from the first user may control the user interface device, for example, while watching the video feed at a remote location.

Typically, while the video feed is being recorded, the disposition of the marker 22 within image frames belonging to the video feed is continuously tracked, and real-time data relating to the disposition of the marker is communicated to the cloud-based, remote computer server (typically from computer processor 23). Similarly, it is typically the case the augmented-reality objects 25 that are to be displayed within the video feed are continuously updated in real-time via user interface device 26, and the selected augmented-reality objects are communicated to the cloud-based, remote computer server. In turn, the cloud-based, remote computer server communicates, to the first site (e.g., to computer processor 23), the selected augmented-reality objects positioned and oriented to correspond to the identified dispositions. Typically, the frame rate at which the augmented-reality objects are communicated from the cloud-based, remote computer server to the first site is configured to match the frame rate at which the video feed is recorded. Further typically, the frequency at which the identified dispositions within image frames belonging to the video feed are communicated to the cloud-based, remote computer server is configured to match the frame rate at which the video feed is recorded, such that a respective disposition is identified and communicated to the cloud-based, remote computer server for each image frame within the video feed.

It is noted it is typically the case that, other than augmented-reality object 25, the image frames that are published (e.g., broadcast) are native video image frames. The only data that are sent from computer processor 23 to cloud-based, remote computer server 24 are data relating to the dispositions within the image frames at which the augmented-reality objects are to be placed. Similarly, the only data that are sent from cloud-based, remote computer server to the first site are data relating to the augmented-reality objects and their positions and orientations. For some applications, the remote computer server communicates a video stream that contains only the augmented-reality objects in the form of an alpha channel to computer processor 23. An alternative communication technique would be (a) to communicate entire image frames from computer processor 23 to cloud-based, remote computer server 24 at the normal resolution and frame rate of the image frames, (b) to overlay the augmented-reality objects upon the image frames at the identified dispositions, at the cloud-based, remote server, and (c) to then communicate the image frames with the augmented-reality objects overlaid upon them from the cloud-based, remote computer server to the first site (or to directly publish the image frames with the augmented-reality objects overlaid upon them from the cloud-based, remote computer server).

Typically, the technique described hereinabove with reference to FIGS. 1A and 1B uses low communication and processing resources relative to the alternative communication technique, since the only data that need to communicated from the first site to the second site, and vice versa, are the disposition-related data (from the first site to the second site) and the augmented-reality objects and their positions and orientations (from the second site to the first site, e.g., in the format of alpha channels). For some applications of the present invention, entire image frames and/or portions thereof are communicated to the cloud-based, remote server, but at a reduced resolution and/or frame rate. The cloud-based, remote computer server uses the reduced resolution (and/or reduced frame rate) image frames to identify the disposition of the marker within the image frames, and to overlay the augmented-reality objects on the image frames, based upon the identified disposition. In this manner, the required communication and processing resources are less than would be required if the entire image frames and/or portions thereof were to be communicated to the cloud-based, remote computer server at their normal resolution and frame rate. For some applications of the present invention, the alternative communication technique described hereinabove is used in combination with some of the other techniques described herein (such as the techniques described herein relating to the selection of the augmented-reality object that are to be displayed, in real-time with respect to the recording of the video).

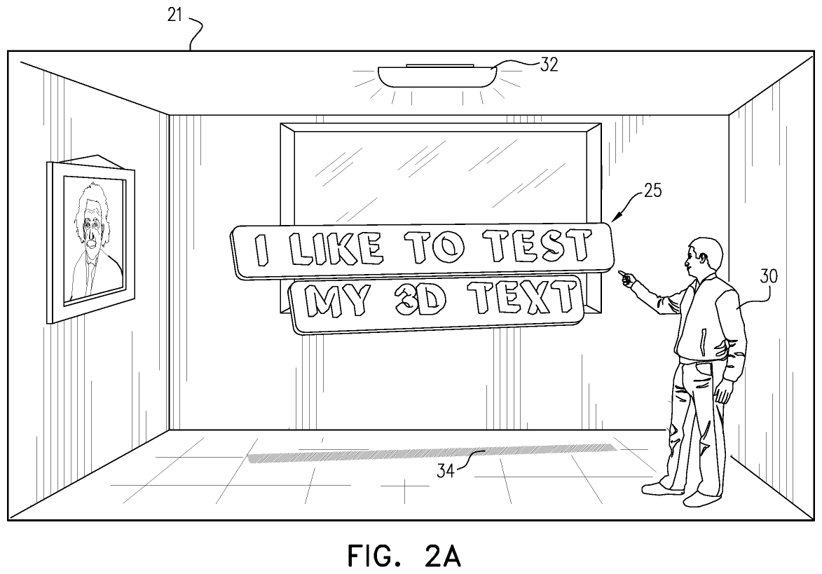

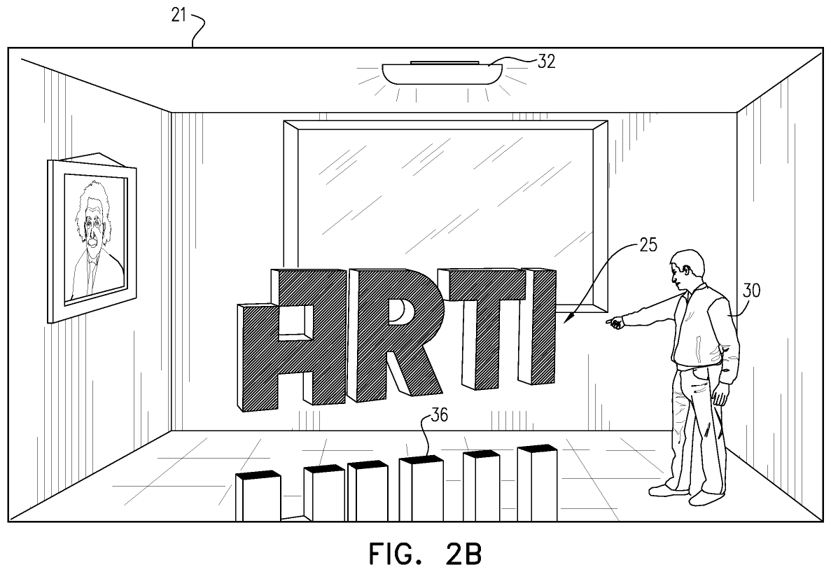

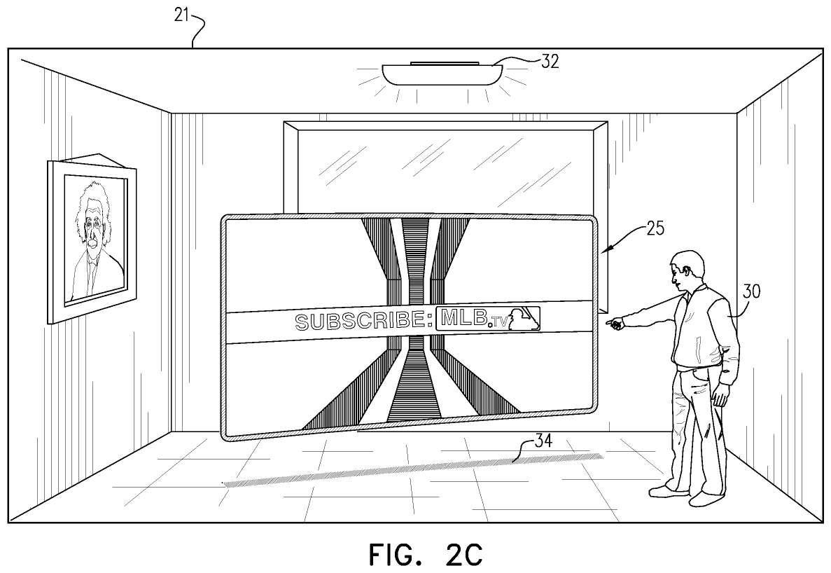

Reference is now made to FIGS. 2A, 2B and 2C, which are schematic illustrations of examples of frames of a video feed 21 that include augmented reality objects 25 overlaid thereon, in accordance with some applications of the present invention. FIG. 2A shows an example of 3D text overlaid upon the video feed, FIG. 2B shows an example of a 3D graphic overlaid upon the video feed, and FIG. 2C shows an example of a video that is embedded within the video feed.

For some applications, lighting-related parameters of the augmented-reality objects and lighting-related parameters within image frames of the video feed are automatically matched to each other. The automatic matching is typically performed such that the lighting-related parameters of the augmented-reality objects correspond to lighting-related parameters that one would expect the augmented-reality objects to have if they were really disposed at the dispositions at which they are placed within the image frames. For example, as shown in FIGS. 2A and 2B, for some applications, the position of a light 32 relative to augmented reality object 25 is detected, and based on the relative position of the light with respect to the augmented reality object, a shadow 34 of the augmented reality object is added. Alternatively or additionally, as shown in FIG. 2B, a reflection 36 of the augmented reality object is added.

Typically, the lighting-related parameters include light intensity, light-source angle, white balance, light-source position, light-source type, etc. For some applications, a machine-learning algorithm is used to perform the aforementioned step. For some such applications, an algorithm is run that first determines the light-related parameters within an image frame, and then applies light-related parameters to the augmented-reality object based on the light-related parameters that were determined in the first step. Alternatively, an algorithm may be run that determines which lighting-related parameters to apply to the augmented-reality object in order to match the lighting- related parameters of the augmented-reality objects to those of the image frame, without directly determining the lighting-related parameters within the image frame.

As shown in FIGS. 1A and 1B and as described hereinabove, for some applications, user 30 appears in the video feed. For some applications, computer processor 23 and/or cloud-based, remote computer server 24 is configured to receive inputs (e.g., gestures) from the user who appears in the video feed and to adjust the augmented-reality object in response to the inputs. For example, the size, position, and/or orientation of the augmented-reality objects may be changed in response to gestures from the user. Alternatively or additionally, computer processor 23 and/or cloud-based, remote computer server 24 is configured to change the augmented-reality object in response to gestures from user 30. An example of this is schematically illustrated in FIGS. 2A and 2B. As shown, in FIG. 2A, user 30 has his hand right hand raised relative to its position in FIG. 2B. Correspondingly, augmented reality object 25 shown in FIG. 2A is raised from the floor relative to the position of the augmented reality object as shown in FIG. 2B.

As described hereinabove, for some applications, the one or more dispositions (i.e., positions and/or orientations) within image frames belonging to the video feed at which to place the augmented-reality objects are identified by identifying the dispositions of one or more markers 22 within the image frames. For some applications, techniques are performed in order to reduce the visibility of the markers within image frames belonging to the video that is published. For some applications, (a) characteristics of an area of the image frame that surrounds the marker are identified, and (b) a mask is overlaid upon the marker, such that the mask blends in with the surrounding area. For some applications, a machine-learning algorithm automatically generates such as mask. For some applications, the effect of overlaying the mask upon the marker is as if the marker has been removed from the image frame.

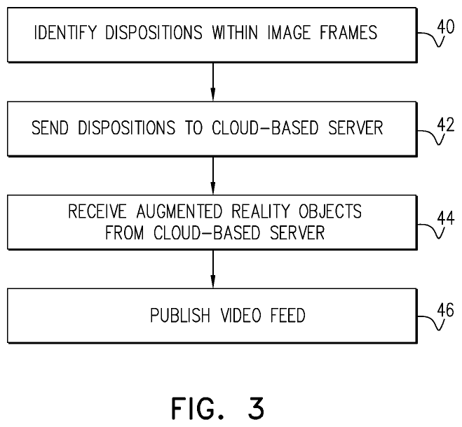

FIG. 3 is a flowchart showing steps of a method that are performed in accordance with some applications of the present invention. In accordance with the description of FIGS. 1A and 1B, in a first step 40, typically one or more dispositions are identified within image frames belonging to a video feed (e.g., by identifying markers within the images) that is recorded at a first site. For some applications, in a second step 42, data that are indicative of the one or more dispositions within the image frames belonging to the video feed are communicated to cloud-based, remote computer server 24 that is remote from the first site. Typically, in a third step 44, one or more augmented-reality objects are received from the cloud-based, remote computer server, the augmented-reality objects being positioned and oriented to correspond to the identified dispositions. For some applications, in step 46, a video feed is published with the augmented- reality objects overlaid upon the image frames. Typically, all of the above-mentioned steps are performed in real-time with respect to the recording of the video feed.

It is noted that in the techniques described hereinabove, the augmented-reality objects are communicated from the cloud-based, remote computer server to the first site, and the video feed is then published (e.g., broadcast) from the first site. However, the scope of the present application includes publishing the video at the cloud-based, remote computer server, mutatis mutandis. For some such applications, the cloud-based, remote computer server drives computer processor 23 to publish the video feed, and the cloud-based, remote computer server overlays the augmented-reality objects upon image frames belonging to the video feed directly onto the published video feed, without communicating the augmented-reality objects directly to the first site. For some applications, the overlaying and the publishing of the video with the augmented-reality objects overlaid upon the video is performed by a further computer processor that is remote from both the first and second sites.

Applications of the invention described herein can take the form of a computer program product accessible from a computer-usable or computer-readable medium (e.g., a non-transitory computer-readable medium) providing program code for use by or in connection with a computer or any instruction execution system, such as computer processor 23 or cloud-based, remote computer server 24, and/or computer processor 27 of user interface device 26. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Typically, the computer-usable or computer readable medium is a non-transitory computer-usable or computer readable medium.

Examples of a computer-readable medium include a semiconductor or solid state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor (e.g., computer processor 23 or cloud-based, remote computer server 24, and/or computer processor 27 of user interface device 26) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. The system can read the inventive instructions on the program storage devices and follow these instructions to execute the methodology of the embodiments of the invention.

Network adapters may be coupled to the processor to enable the processor to become coupled to other processors or remote printers or storage devices through intervening private or public networks. Modems, cable modem and Ethernet cards are just a few of the currently available types of network adapters.

Computer program code for carrying out operations of the present invention may be written in any combination of one or more programming languages, including an object-oriented programming language such as Java, Smalltalk, C++ or the like and conventional procedural programming languages, such as the C programming language or similar programming languages.

It will be understood that algorithms described herein, can be implemented by computer program instructions. These computer program instructions may be provided to a processor of a general-purpose computer, special purpose computer, or other programmable data processing apparatus to produce a machine, such that the instructions, which execute via the processor of the computer (e.g., computer processor 23 or cloud-based, remote computer server 24, and/or computer processor 27 of user interface device 26) or other programmable data processing apparatus, create means for implementing the functions/acts specified in the algorithms described in the present application. These computer program instructions may also be stored in a computer- readable medium (e.g., a non-transitory computer-readable medium) that can direct a computer or other programmable data processing apparatus to function in a particular manner, such that the instructions stored in the computer-readable medium produce an article of manufacture including instruction means which implement the function/act specified in the algorithms. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the algorithms described in the present application.

Computer processor 23 or cloud-based, remote computer server 24, and/or computer processor 27 of user interface device 26 is typically a hardware device programmed with computer program instructions to produce a special purpose computer. For example, when programmed to perform the algorithms described herein, computer processor 23 or cloud-based, remote computer server 24, and/or computer processor 27 of user interface device 26 typically acts as a special purpose video-publishing computer processor. Typically, the operations described herein that are performed by computer processor 23 or cloud-based, remote computer server 24, and/or computer processor 27 of user interface device 26 transform the physical state of a memory, which is a real physical article, to have a different magnetic polarity, electrical charge, or the like depending on the technology of the memory that is used.

### EXAMPLES

A system as described herein has been successfully utilized in numerous setting.

For example, the system was used for a BBC broadcast during the 2020 US Presidential Election, as demonstrated at the following link: https://www.youtube.com/watch?v=AgGxza6NeQ

The system was also used in an eNCA News broadcast, as demonstrated at the following link: https://www.youtube.com/watch?v=MKLE8ioEsXQ&t

Another example of the use of the system is in a BBC News broadcast that was recorded outside of a studio setting. The system was used to add augmented-reality charts containing data relating to the COVID-19 epidemic, as the video was broadcast. This may be observed at the following link: https://www.youtube.com/watch?v=3-18HQNmdAg

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method for publishing video content, based upon a video feed that is recorded at a first site, the method comprising:
in real-time with respect to the recording of the video feed, and using one or more computer processors:
identifying one or more dispositions within image frames belonging to the video feed;
communicating data that are indicative of the one or more dispositions within the image frames belonging to the video feed to a cloud-based, remote computer server that is remote from the first site;
receiving one or more augmented-reality objects from the cloud-based, remote computer server, the augmented-reality objects being positioned and oriented to correspond to the positions identified within the image frames belonging to the video feed; and
publishing the video feed with the augmented-reality objects overlaid upon the image frames.

2. (canceled)

3. The method according to claim 1, wherein the one or more augmented- reality objects include one or more augmented-reality objects selected from the group consisting of: a title, text, a photograph, a video, a graphs, a 3D-object, a website, a social media feed, and any combination thereof.

4. The method according to claim 1, wherein the one or more augmented-reality objects include a data source from an application programming interface.

5. The method according to claim 1, wherein the video feed has a given frame rate, and wherein receiving the augmented-reality objects from the cloud-based, remote computer server comprises receiving the augmented-reality objects from the cloud-based, remote computer server at a frame rate that matches the given frame rate.

6. The method according to claim 1, wherein identifying the one or more dispositions within image frames belonging to the video feed comprises, for respective image frames belonging to the video feed, identifying dispositions that are different from each other.

7. The method according to claim 1,
further comprising, in real-time with respect to the recording of the video feed, selecting the one or more augmented-reality objects that are to be overlaid upon respective portions of the video feed,
wherein receiving the augmented-reality objects from the cloud-based, remote computer server comprises receiving the selected augmented-reality objects from the cloud-based, remote computer server in real-time with respect to the selecting of the one or more augmented-reality objects.

8. (canceled)

9. The method according to claim 1, further comprising receiving a gesture from a user who appears within the video feed, and in response thereto adjusting the augmented-reality object.

10-12. (canceled)

13. The method according to claim 1, wherein receiving the one or more augmented-reality objects from the cloud-based, remote computer server comprises receiving an alpha channel that contains the one or more augmented-reality objects from the cloud-based, remote computer server.

14. The method according to claim 13, wherein receiving the alpha channel from the cloud-based, remote computer server comprises receiving an alpha channel that is generated using a gaming engine.

15. The method according to claim 1, wherein identifying one or more dispositions within image frames belonging to the video feed comprises identifying dispositions of one or more physical markers that are located within the image frames belonging to the video feed.

16. The method according to claim 15, further comprising at least partially reducing a visibility of the one or more physical markers within the image frames.

17. (canceled)

18. The method according to claim 16, wherein reducing the visibility of the one or more physical markers within the image frame comprises, within each of the image frames:
identifying characteristics of areas of the image frame that surround each of the one or more physical markers, and
generating masks to overlay upon the one or more markers, such that the masks blend in with corresponding surrounding areas.

19. The method according to claim 16, wherein reducing the visibility of the one or more physical markers within the image frame comprises running a machine-learning algorithm that generates masks to overlay upon the one or more markers, such that the masks blend in with areas that surround each of the one or more physical markers.

20. The method according to claim 1, further comprising automatically matching lighting-related parameters of the one or more augmented-reality objects with lighting-related parameters within image frames of the video feed.

21. The method according to claim 20, wherein automatically matching the lighting-related parameters comprises matching one or more lighting-related parameters selected from the group consisting of: light intensity, light-source angle, white balance, light-source type, and light-source position.

22. The method according to claim 20, wherein automatically matching the lighting-related parameters comprises automatically matching the lighting-related parameters by running a machine learning-algorithm.

23. The method according to claim 20, wherein automatically matching the lighting-related parameters comprises determining lighting-related parameters within the image frames, and applying lighting-related parameters to the augmented-reality objects based on the lighting-related parameters that were determined within the image frames.

24. The method according to claim 20, wherein automatically matching the lighting-related parameters comprises determining lighting-related parameters to apply to the augmented-reality objects in order to match the lighting-related parameters of the augmented-reality objects to those of the image frames, without directly determining the lighting-related parameters within the image frames.

25. (canceled)

26. An apparatus for publishing video content on a video output device, based upon a video feed that is recorded at a first site, the apparatus comprising:
one or more computer processors configured, in real-time with respect to the recording of the video feed, to:
identify one or more dispositions within image frames belonging to the video feed;
communicate data that are indicative of the one or more dispositions within the image frames belonging to the video feed to a cloud-based, remote computer server that is remote from the first site;
receive one or more augmented-reality objects from the cloud-based, remote computer server, the augmented-reality objects being positioned and oriented to correspond to the positions identified within the image frames belonging to the video feed; and
publish the video feed on the video output device, with the augmented-reality objects overlaid upon the image frames.

27. (canceled)

28. The apparatus according to claim 26, wherein the one or more augmented-reality objects include one or more augmented-reality objects selected from the group consisting of: a title, text, a photograph, a video, a graphs, a 3D-object, a website, a social media feed, and any combination thereof.

29. The apparatus according to claim 26, wherein the one or more augmented-reality objects include a data source from an application programming interface.

30. The apparatus according to claim 26, wherein the video feed has a given frame rate, and wherein the one or more computer processors are configured to receive the augmented-reality objects from the cloud-based, remote computer server at a frame rate that matches the given frame rate.

31. The apparatus according to claim 26, wherein the one or more computer processors are configured to identify the one or more dispositions within image frames belonging to the video feed by identifying dispositions that are different from each other, for respective image frames belonging to the video feed.

32. The apparatus according to claim 26, wherein the one or more computer processors are configured:
in real-time with respect to the recording of the video feed, to receive an input indicating a selection of the one or more augmented-reality objects that are to be overlaid upon respective portions of the video feed, and
to receive the selected augmented-reality objects from the cloud-based, remote computer server in real-time with respect to the selecting of the one or more augmented- reality objects.

33. (canceled)

34. The apparatus according to claim 26, wherein the one or more computer processors are configured to receive a gesture from a user who appears within the video feed, and in response thereto to adjust the augmented-reality object.

35-37. (canceled)

38. The apparatus according to claim 26, wherein the one or more computer processors are configured to receive the one or more augmented-reality objects from the cloud-based, remote computer server by receiving an alpha channel that contains the one or more augmented-reality objects from the cloud-based, remote computer server.

39. The apparatus according to claim 38, wherein the one or more computer processors are configured to receive the alpha channel from the cloud-based, remote computer server by receiving an alpha channel that is generated using a gaming engine.

40. The apparatus according to claim 26, wherein the one or more computer processors are configured to identify the one or more dispositions within image frames belonging to the video feed by identifying dispositions of one or more physical markers that are located within the image frames belonging to the video feed.

41. The apparatus according to claim 40, wherein the one or more computer processors are configured to at least partially reduce a visibility of the one or more physical markers within the image frames.

42. (canceled)

43. The apparatus according to claim 41, wherein the one or more computer processors are configured to at least partially reduce the visibility of the one or more physical markers within the image frame by, within each of the image frames:
identifying characteristics of areas of the image frame that surround each of the one or more physical markers, and
generating masks to overlay upon the one or more markers, such that the masks blend in with corresponding surrounding areas.

44. The apparatus according to claim 41, wherein the one or more computer processors are configured to at least partially reduce the visibility of the one or more physical markers within the image frame by running a machine-learning algorithm that generates masks to overlay upon the one or more markers, such that the masks blend in with areas that surround each of the one or more physical markers.

45. The apparatus according to claim 26, wherein the one or more computer processors are configured to automatically match lighting-related parameters of the one or more augmented-reality objects with lighting-related parameters within image frames of the video feed.

46. The apparatus according to claim 45, wherein the one or more computer processors are configured to automatically match one or more lighting-related parameters selected from the group consisting of: light intensity, light-source angle, white balance, light-source type, and light-source position.

47. The apparatus according to claim 45, wherein the one or more computer processors are configured to automatically match the lighting-related parameters by running a machine learning-algorithm.

48. The apparatus according to claim 45, wherein the one or more computer processors are configured to automatically match the lighting-related parameters by determining lighting-related parameters within the image frames, and applying lighting-related parameters to the augmented-reality objects based on the lighting-related parameters that were determined within the image frames.

49. The apparatus according to claim 45, wherein the one or more computer processors are configured to automatically match the lighting-related parameters by determining lighting-related parameters to apply to the augmented-reality objects in order to match the lighting-related parameters of the augmented-reality objects to those of the image frames, without directly determining the lighting-related parameters within the image frames.

50. An apparatus for publishing video content on a video output device, based upon a video feed that is recorded at a first site, the apparatus comprising:
one or more computer processors configured, in real-time with respect to the recording of the video feed, and using a cloud-based computer server disposed at a second site that is remote from the first site:
to receive an identification of one or more dispositions identified within image frames belonging to the video feed;
to receive an indication of one or more augmented-reality objects to be displayed within the video feed; and
to publish the video feed with the augmented-reality objects overlaid upon the image frames belonging to the video feed at positions and orientations corresponding to the one or more dispositions that were identified within the image frames.

51-52. (canceled)
